(19) United States
(12) Patent Application Publication
(10) Pub. No.: US 2005/0071657 A1
(43) Pub. Date: Mar. 31, 2005

(54) Method and system for securing digital assets using time-based security criteria

(75) Inventor: Nicholas M. Ryan, Sunnyvale, CA (US)

Correspondence Address: BEYER WEAVER & THOMAS LLP, P.O. BOX 70250, OAKLAND, CA, 94612-0250, US

(73) Assignee: PSS Systems, Inc.

(21) Appl. No.: 10/676,850

(22) Filed: Sep. 30, 2003

(51) Int. Cl. H04L 9/32

(52) U.S. Cl. 713/193

(57) ABSTRACT

Techniques for utilizing time-based security criteria in a file security system are disclosed. At least a portion of the security criteria can have a time associated therewith (i.e., time-based security criteria) that serves as a time-based restriction on the ability to gain access to electronic files. If the time-based restriction is not satisfied, then the associated security criteria is not made available and thus access to a secured electronic file is prevented. In other words, access restrictions on electronic files can be dependent on the time at which access to the electronic files is attempted. The security criteria can pertain to keys (or ciphers) used by the file security system to secure (e.g., encrypt) electronic files to be secured, or to unsecure (e.g., decrypt) electronic files already secured.

### CROSS-REFERENCE TO RELATED APPLICATIONS

This application is related to: (i) U.S. patent application Ser. No. 10/246,079, filed Sep. 17, 2002, and entitled “METHOD AND APPARATUS FOR GENERATING KEYS FROM ACCESS RULES IN A DECENTRALIZED MANNER AND METHODS THEREFOR,” which is hereby incorporated herein by reference; (ii) U.S. patent application Ser. No. 10/186,203, filed Jun. 26, 2002, and entitled “METHOD AND SYSTEM FOR IMPLEMENTING CHANGES TO SECURITY POLICIES IN A DISTRIBUTED SECURITY SYSTEM,” which is hereby incorporated herein by reference; (iii) U.S. patent application Ser. No. 10/159,537, filed May 5, 2002, and entitled “METHOD AND APPARATUS FOR SECURING DIGITAL ASSETS,” which is hereby incorporated herein by reference; and (iv) U.S. patent application Ser. No. 10/127,109, filed Apr. 22, 2002, and entitled “EVALUATION OF ACCESS RIGHTS TO SECURED DIGITAL ASSETS,” which is hereby incorporated herein by reference.

### BACKGROUND OF THE INVENTION

1. Field of the Invention

The present invention relates to security systems for data and, more particularly, to security systems that protect electronic files in an inter/intra enterprise environment.

2. Description of Related Art

The Internet is the fastest growing telecommunications medium in history. This growth and the easy access it affords have significantly enhanced the opportunity to use advanced information technology for both the public and private sectors. It provides unprecedented opportunities for interaction and data sharing among businesses and individuals. However, the advantages provided by the Internet come with a significantly greater element of risk to the confidentiality and integrity of information. The Internet is an open, public and international network of interconnected computers and electronic devices. Without proper security means, an unauthorized person or machine may intercept information traveling across the Internet and even gain access to proprietary information stored in computers that interconnect to the Internet.

There are many efforts in progress aimed at protecting proprietary information traveling across the Internet and controlling access to computers carrying the proprietary information. Cryptography allows people to carry over the confidence found in the physical world to the electronic world, thus allowing people to do business electronically without worries of deceit and deception. Every day millions of people interact electronically, whether it is through e-mail, e-commerce (business conducted over the Internet), ATM machines, or cellular phones. The perpetual increase of information transmitted electronically has led to an increased reliance on cryptography.

One of the ongoing efforts in protecting the proprietary information traveling across the Internet is to use one or more cryptographic techniques to secure a private communication session between two communicating computers on the Internet. The cryptographic techniques provide a way to transmit information across an unsecure communication channel without disclosing the contents of the information to anyone eavesdropping on the communication channel. Using an encryption process in a cryptographic technique, one party can protect the contents of the data in transit from access by an unauthorized third party, yet the intended party can read the encrypted data after using a corresponding decryption process.

A firewall is another security measure that protects the resources of a private network from users of other networks. However, it has been reported that many unauthorized accesses to proprietary information occur from the inside, as opposed to from the outside. An example of someone gaining unauthorized access from the inside is when restricted or proprietary information is accessed by someone within an organization who is not supposed to do so. Due to the open nature of networks, contractual information, customer data, executive communications, product specifications, and a host of other confidential and proprietary intellectual property remain available and vulnerable to improper access and usage by unauthorized users within or outside a supposedly protected perimeter.

Many businesses and organizations have been looking for effective ways to protect their proprietary information. Typically, businesses and organizations have deployed firewalls, Virtual Private Networks (VPNs) and Intrusion Detection Systems (IDS) to provide protection. Unfortunately, these various security means have been proven insufficient to reliably protect proprietary information residing on private networks. For example, depending on passwords to access sensitive documents from within often causes security breaches when the password of a few characters long is leaked or detected. Consequently, various cryptographic means are deployed to provide restricted access to electronic data in security systems.

One problem that exists for security systems is that it is either not possible or cumbersome and difficult to provide that secured electronic documents are permitted to be accessed only after a certain date has passed. Further, even if possible, the conventional techniques utilized would not provide a robust, cryptographically secure solution. Therefore, there is a need to provide more effective ways for security systems to impose time-related access restrictions on accessing electronic resources protected by the security systems.

### SUMMARY OF THE INVENTION

The invention relates to techniques for utilizing time-based security criteria in a file security system. At least a portion of the security criteria can have a time associated therewith (i.e., time-based security criteria) that serves as a time-based restriction on the ability to gain access to electronic files. If the time-based restriction is not satisfied, then the associated security criteria is not made available and thus access to a secured electronic file is prevented. In other words, access restrictions on electronic files can be dependent on the time at which access to the electronic files is attempted. The security criteria can pertain to keys (or ciphers) used by the file security system to secure (e.g., encrypt) electronic files to be secured, or to unsecure (e.g., decrypt) electronic files already secured.

The invention can be implemented in numerous ways, including as a method, system, device, and computer readable medium. Several embodiments of the invention are discussed below.

As a file security system for restricting access to electronic files, one embodiment of the invention includes at least: a key store that stores a plurality of cryptographic key pairs, each of the cryptographic key pairs includes a public key and a private key, at least one of the cryptographic key pairs pertaining to a predetermined time; and an access manager operatively connected to the key store, the access manager determines whether the private key of the at least one of the cryptographic key pairs that pertains to the predetermined time is permitted to be provided to a requestor based on a current time. The requester requires the private key of the at least one of the cryptographic key pairs that pertains to the predetermined time to access to a secured electronic file. The secured electronic file was previously secured using the public key of the at least one of the cryptographic key pairs that pertains to the predetermined time.

As a method for restricting access to an electronic document, one embodiment of the invention includes at least the acts of: identifying an electronic document to be secured, the electronic document having at least a data portion that contains data; obtaining a time-based access key; securing the electronic document through use of the time-based access key to produce a secured electronic document; and storing the secured electronic document.

As a method for restricting access to an electronic document, one embodiment of the invention includes at least the acts of: identifying an electronic document to be secured, the electronic document having at least a data portion that contains data; obtaining a document key; encrypting the data portion of the electronic document using the document key to produce an encrypted data portion; obtaining a time-based access key; encrypting the document key using the time-based access key to produce an encrypted document key; forming a secured electronic document from at least the encrypted data portion and the encrypted document key; and storing the secured electronic document.

As a method for distributing cryptographic keys used in a file security system, one embodiment of the invention includes at least the acts of: receiving a request for a time-based key; identifying an access time associated with the time-based key; comparing a current time with the access time; and refusing to distribute the time-based key in response to the request when the comparing indicates that the current time is prior to the access time.

As a computer readable medium including at least computer program code for restricting access to an electronic document, one embodiment of the invention includes at least: computer program code for identifying an electronic document to be secured, the electronic document having at least a data portion that contains data; computer program code for obtaining a time-based access key; computer program code for securing the electronic document through use of the time-based access key to produce a secured electronic document; and computer program code for storing the secured electronic document.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the invention will become better understood with regard to the following description, appended claims and accompanying drawings, wherein:

FIG. 1 is a block diagram of a file security system according to one embodiment of the invention.

FIG. 2 is a flow diagram of a file securing process according to one embodiment of the invention.

FIGS. 3A and 3B are flow diagrams of a document securing process according to one embodiment of the invention.

FIG. 4 is a flow diagram of a document unsecuring process according to one embodiment of the invention.

FIG. 5 is a flow diagram of an access key retrieval process according to one embodiment of the invention.

FIG. 6 shows a basic security system in which the invention may be practiced in accordance with one embodiment thereof.

FIG. 7 shows an exemplary data structure of a secured file that may be used in one embodiment of the invention.

### DETAILED DESCRIPTION OF THE INVENTION

The invention relates to techniques for utilizing time-based security criteria in a file security system. At least a portion of the security criteria can have a time associated therewith (i.e., time-based security criteria) that serves as a time-based restriction on the ability to gain access to electronic files. If the time-based restriction is not satisfied, then the associated security criteria is not made available and thus access to a secured electronic file is prevented. In other words, access restrictions on electronic files can be dependent on the time at which access to the electronic files is attempted. The security criteria can pertain to keys (or ciphers) used by the file security system to secure (e.g., encrypt) electronic files to be secured, or to unsecure (e.g., decrypt) electronic files already secured.

Secured files are files that require one or more keys, passwords, access privileges, etc. to gain access to their content. The security is often provided through encryption and access rules. The files, for example, can pertain to documents, multimedia files, data, executable code, images and text. In general, a secured file can only be accessed by authenticated users with appropriate access rights or privileges. In one embodiment, each secured file is provided with a header portion and a data portion, where the header portion contains, or points to, security information. The security information is used to determine whether access to associated data portions of secured files is permitted.

In one embodiment, security information provided with an electronic document controls restrictive access to a data portion which is encrypted. The security information can employ access rules together with cipher keys (e.g., a file key and various other keys) to ensure that only those users with proper access privileges or rights can access the encrypted data portion.

As used herein, a user may mean a human user, a software agent, a group of users, a member of the group, a device and/or application. Besides a human user who needs to access a secured document, a software application or agent sometimes needs to access secured files in order to proceed. Accordingly, unless specifically stated, the “user” as used herein does not necessarily pertain to a human being.

The invention is related to processes, systems, architectures and software products for providing pervasive security to digital assets (e.g., electronic documents). The invention is particularly suitable in an enterprise environment. In general, pervasive security means that digital assets are secured (i.e., secured data) and can only be accessed by authenticated users with appropriate access rights or privileges. Digital assets may include, but not be limited to, various types of documents, multimedia files, data, executable code, images and texts.

In the following description, numerous specific details are set forth in order to provide a thorough understanding of the invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order, nor imply any limitations in the invention.

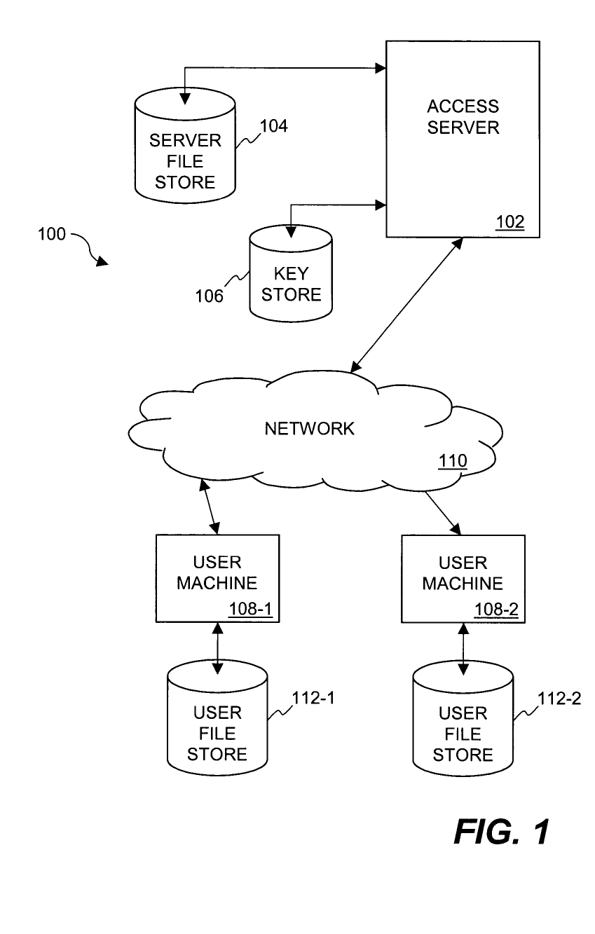

Embodiments of the invention are discussed herein with reference to FIGS. 1-7. However, those skilled in the art will readily appreciate that the detailed description given herein with respect to these figures is for explanatory purposes as the invention extends beyond these limited embodiments.

FIG. 1 is a block diagram of a file security system 100 according to one embodiment of the invention. The file security system 100 includes an access server 102 that provides central management for the file security system 100. The access server 102 can store or retrieve files from a server file store 104. The access server 102 can control the distribution of cryptographic keys from a key store 106. In addition, the access server 102 can generate cryptographic keys that are stored to the key store 106. Alternatively, the access server 102 can store cryptographic keys in the key store 106 that have been received by the access server 102.

The file security system 100 also includes user machines 108 and user file stores 112. The user machines 108 couple to the access server 102 via a network 110. The network 110 can be a private network or a public network. The user machine 108 also has a user file store 112 coupled thereto. The user file store 112 can store electronic files locally for the user of the corresponding user machine 108. On the other hand, the server file store 104 can provide centralized, remote storage of electronic files for any of the users of the user machines 108.

According to the invention, the file security system 100 enables a user at the user machine 108 to secure an electronic file (document) such that access to the secured electronic file is restricted. In one embodiment of the invention, the access restriction is a time-based access restriction. As an example, the access restriction could limit subsequent access to the secured electronic file until after a predetermined time in the future. The predetermined time can be a date in the future or a particular time of day for a date in the future. For example, if the electronic file was created and secured with a time-based access restriction on Jul. 4, 2003, the predetermined time could be any subsequent time, such as Jul. 5, 2003, 12:00 PM on Jul. 31, 2003, or 12:00 AM on Jan. 1, 2004.

Once an electronic file has been secured, a user at a user machine can attempt to access the secured electronic file. In doing so, the user machine for the user would need to access the access server 102 and retrieve the appropriate one or more cryptographic keys from the key store 106 that are needed to unsecure the secured electronic file. However, the access server 102 does not permit the delivery of at least certain cryptographic keys from the key store 106 (private keys) that are used to unsecure secured electronic files unless the predetermined time associated with such key has passed. Typically, the cryptographic keys needed to unsecure a secured electronic file are private keys. Here, those of the private keys that are associated to predetermined times are not supplied from the key store (or access server 102) until after the associated predetermined time has passed. For example, a private key associated with a predetermined time restriction of Jul. 4, 2003 would not be available on Jul. 3, 2003 but would be available on Jul. 4, 2003.

Once the private keys have satisfied the time restrictions and have been supplied, the private keys are usable to unsecure the secured electronic documents. An administrator of the file security system 100 can later decide to expire the private keys so further dissemination of the necessary private keys occurs. However, those that have already received the private keys can continue to have access to the corresponding secured electronic documents.

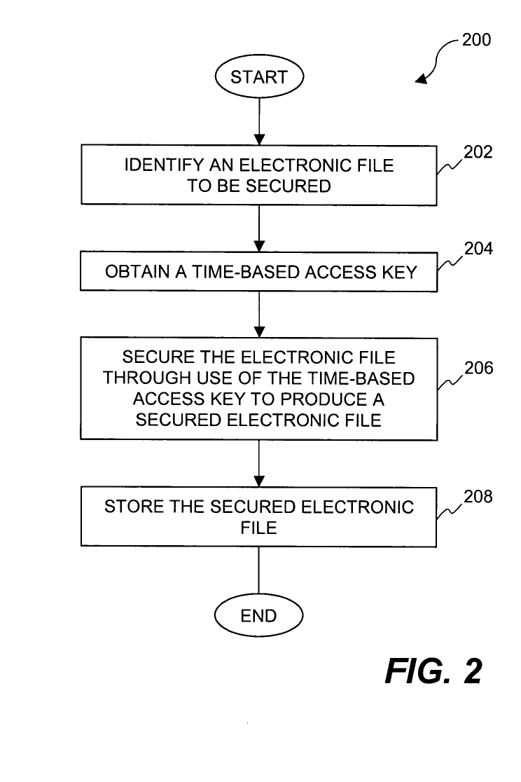

FIG. 2 is a flow diagram of a file securing process 200 according to one embodiment of the invention. The file securing process 200 is, for example, performed by a computing device, such as the access server 102 or the user machines 108 illustrated in FIG. 1.

The file securing process 200 initially identifies 202 an electronic file to be secured. Here, the electronic file is identified to the computing device carrying out the file securing process 200. A user of the computing device may assist in the identification of the electronic file. After the electronic file to be secured has been identified 202, a time-based access key is obtained 204. Typically, the time-based access key is obtained 204 from an access server. For example, if the file securing process 200 is performed by the user machine 108, the time-based access key can be retrieved remotely from the access server 102. Here, the time-based access key is a public key and is normally readily available.

Next, after the time-based access key has been obtained 204, the electronic file is secured 206 through use of the time-based access key. The result of the securing of the electronic file is to produce a secured electronic file. Typically, the secured electronic file is cryptographically secured through encryption (directly or indirectly) using the time-based access key. Thereafter, the secured electronic file is stored 208. After the secured electronic file is stored 208, the file securing process 200 ends.

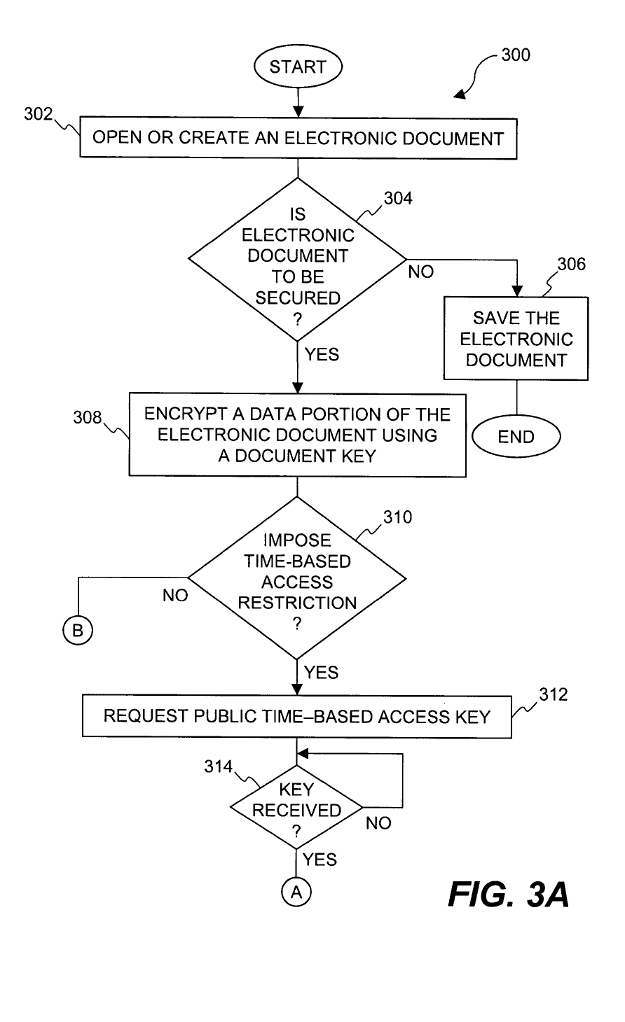

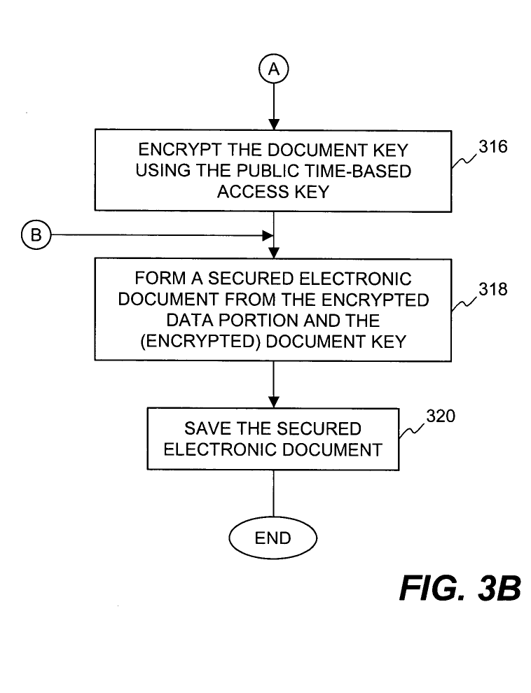

FIGS. 3A and 3B are flow diagrams of a document securing process 300 according to one embodiment of the invention. The document securing process 300 is, for example, performed by a computing device, such as the access server 102 or the user machines 108 illustrated in FIG. 1.

The document securing process 300 opens or creates 302 an electronic document. At this point, the electronic document is unsecure, which is often referred to as being in the “clear.” Next, a decision 304 determines whether the electronic document is to be secured. Here, the user or creator of the electronic document has the option of securing the document, if so desired. When the decision 304 determines that the electronic document is not to be secured, then the electronic document is saved 306. Here, the electronic document being saved is not secured. Following the block 306, the document securing process 300 ends with the electronic document being saved in an unsecured fashion.

On the other hand, when the decision 304 determines that the electronic document is to be secured, then a data portion of the electronic document is encrypted 308 using a document key. The document key can be a cryptographic key that is generated or obtained. Typically, each document managed and secured by the file (document) security system would be encrypted 308 using a different document key. After the data portion of the electronic document has been encrypted 308, a decision 310 determines whether a time-based access restriction on the electronic document should be imposed. Again, the user or creator of the electronic document has the option of securing the document with a time-based access restriction, if so desired.

When the decision 310 determines that a time-based access restriction should be imposed on the electronic document, a public time-based access key is requested 312. In one embodiment, the public time-based access key can be requested from the access server 102 by the user machine 108. The access server 102 can then retrieve or generate the public time-based access key and supply it to the user machine 108. In an alternative implementation, the user machine may have already received the public time-based access key and thus would not need to request such.

Next, a decision 314 determines whether the public time-based access key has been received. Once the decision 314 determines that the public time-based access key has been received (or already available), the document key is encrypted 316 using the public time-based access key. Here, the document key is being encrypted using the public time-based access key. In other words, the public time-based access key is indirectly used to encrypt the electronic document by encryption of the document key. Next, a secured electronic document is formed 318 from the encrypted data portion in the encrypted document key. Thereafter, the secured electronic document is saved 320. In this case, following the block 320, the document securing process 300 ends with the electronic document being saved in a secured fashion with a time-based access restriction.

Alternatively, when the decision 310 determines that a time-based access restriction is not to be imposed on the electronic document, then the blocks 312-316 are bypassed. In such case, the secured electronic document is formed 318 from the encrypted data portion and the document key. In this case, the document key is not encrypted using a public time-based access key. The resulting secured electronic document is then saved 320. In this case, following the block 320, the document securing process 300 ends with the electronic document being saved in a secured fashion without any time-based access restrictions.

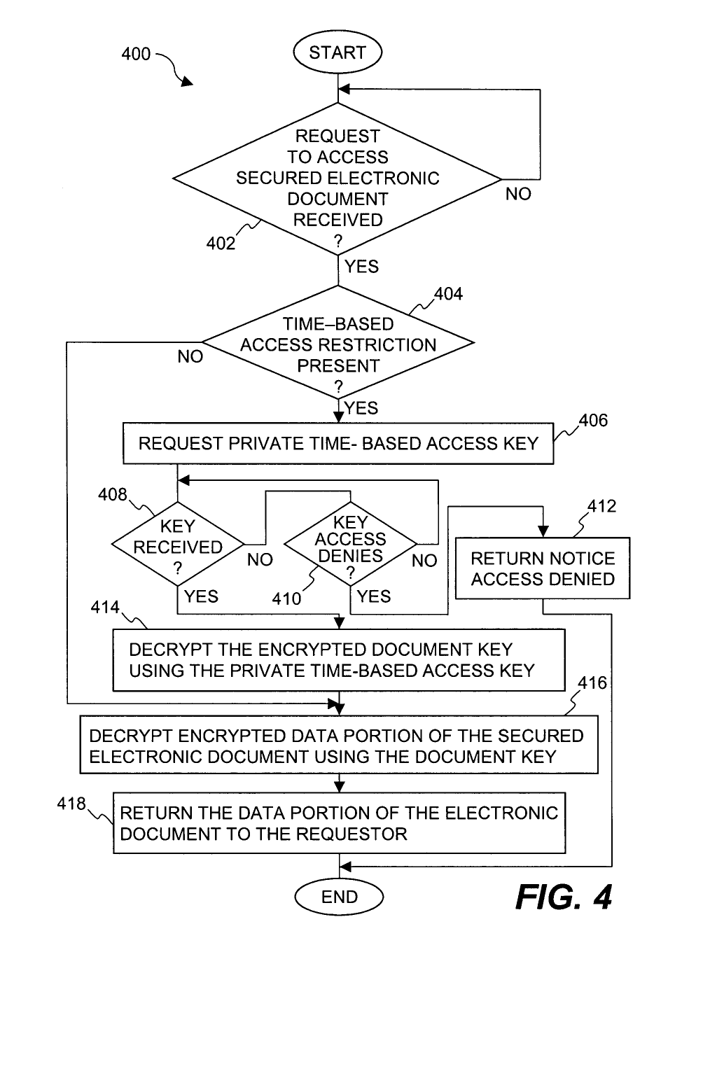

FIG. 4 is a flow diagram of a document unsecuring process 400 according to one embodiment of the invention. The document unsecuring process 400 can be performed at a client machine or a server machine, such as the user machine 108 or the access server 102 illustrated in FIG. 1.

The document unsecuring process 400 begins with a decision 402 that determines whether a request to access a secured electronic document has been received. When the decision 402 determines that a request to access a secured electronic document has not yet been received, the document unsecuring process 400 awaits such a request. In other words, the document unsecuring process 400 can be considered to be invoked once access to a secured electronic document is requested.

Once the decision 402 determines that a request to access a secured electronic document has been received, a decision 404 determines whether a time-based access restriction is present. In one implementation, the decision 404 can evaluate a header portion of the secured electronic document to determine whether a time-based access restriction is present. In another implementation, the decision 404 can evaluate a system policy to determine whether a time-based access restriction is present. As an example, the header can include an indicator of a time-based access restriction. When the decision 404 determines that a time-based access restriction is present, then a private time-based access key is requested 406. In one embodiment, the private time-based access key is requested 406 from a file security system, such as a server machine thereof (e.g., access server 102). Then, a decision 408 determines whether the requested key has been received. When the decision 408 determines that the requested key has not yet been received, a decision 410 determines whether access to the requested key has been denied. Typically, the private time-based access key is only able to be obtained if a predetermined time associated with the private time-based access key has been exceeded. In one embodiment, the access server 102 controls access to the private time-based access key which is stored in the key store 106. Hence, the access server 102 would deny any request for the time-based access key if the predetermined time has not been exceeded. In any case, when the decision 410 determines that access to the requested key has been denied, then access to the secured electronic document is denied and notice that access has been denied is returned 412. Following the block 412, the document unsecuring process 400 ends with access to the secured electronic document being denied.

On the other hand, when the decision 410 determines that access to the requested key has not been denied, then the document unsecuring process 400 returns to repeat the decision 408 so as to wait for the requested key to be received. Once the decision 408 determines that the requested key (the private time-based access key) has been received, the encrypted document key from the secured electronic document is decrypted 414 using the private time-based access key to yield the document key (unencrypted). Here, in one embodiment, a header portion of the secured electronic document includes at least the encrypted document key (as well as the indicator for the private time-based access key). Next, an encrypted data portion of the secured electronic document is decrypted 416 using the document key. Finally, the data portion of the electronic document is then returned 418 to the requester. Additionally, it should be noted that when the decision 404 determines that a time-based access restriction is not present, then the document unsecuring process 400 skips blocks 406-414 and proceeds to block 416. Following block 418, the document unsecuring process 400 ends with access to the secured electronic document being successful.

In one embodiment, the time-based access keys (e.g., the public and private time-based key pair) can be unique (i.e., different) for each day of the year. This advantageously fixes the number of needed keys to a daily granularity. Each day, a new time-based key pair would be generated or otherwise made available so that electronic files that are to become accessible on such day can be unsecured.

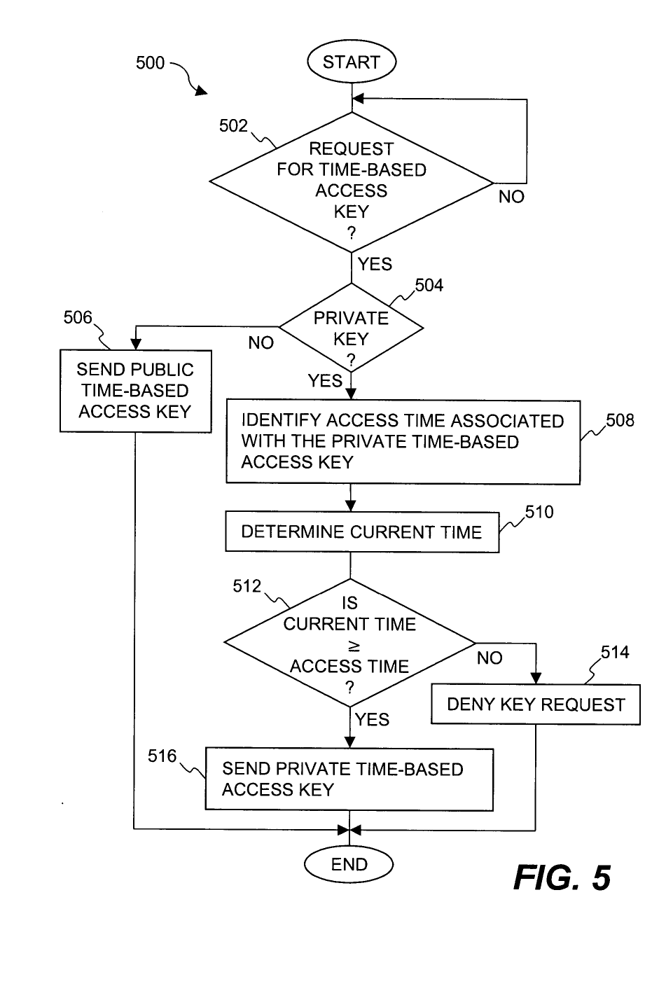

FIG. 5 is a flow diagram of an access key retrieval process 500 according to one embodiment of the invention. The access key retrieval process 500 is, for example, performed by a server machine, such as the access server 102 illustrated in FIG. 1.

The access key retrieval process 500 begins with a decision 502 that determines whether a request for a time-based access key has been received. When the decision 502 determines that a request for a time-based access key has not yet been received, the access key retrieval process 500 awaits such a request. Once the decision 502 determines that a time-based access key has been received, the access key retrieval process 500 continues. In other words, the access key retrieval process 500 can be deemed invoked when a request for a time-based access key is received.

In any case, once the access key retrieval process 500 continues, a decision 504 determines whether the requested access key is a private key. When the decision 504 determines that the requested key is not a private key (i.e., is a public key), then a public time-based access key (which was requested) is sent 506. Typically, the public time-based access key would be sent to a requestor (such as a user machine). In one embodiment, the public time-based access key is retrieved from a remote key store by a server and sent by the server to the requester.

On the other hand, when the decision 504 determines that the requested key is a private key (i.e., a private time-based access key), an access time associated with the private time-based access key to be retrieved is identified 508. A current time is also determined 510. Then, a decision 512 determines whether the current time is greater than or equal to the access time. The decision 512 is used to control whether or not the private time-based access key is permitted to be released to requestors. In other words, if the current time is prior to the access time, then the requestor is not permitted to receive the private time-based access key. As a consequence, the requester would not be able to utilize secured electronic documents that have been secured with a time restriction, where the time restriction is imposed through use of the private time-based access key that corresponds to the private time-based access key. Accordingly, when the decision 512 determines that the current time is not greater than or equal to the access time, then the key request is denied 514. Alternatively, when the current time is greater than or equal to the access time, then the private time-based access key is sent 516 to the requester. Following the blocks 506, 514 and 516, the access key retrieval process 500 ends.

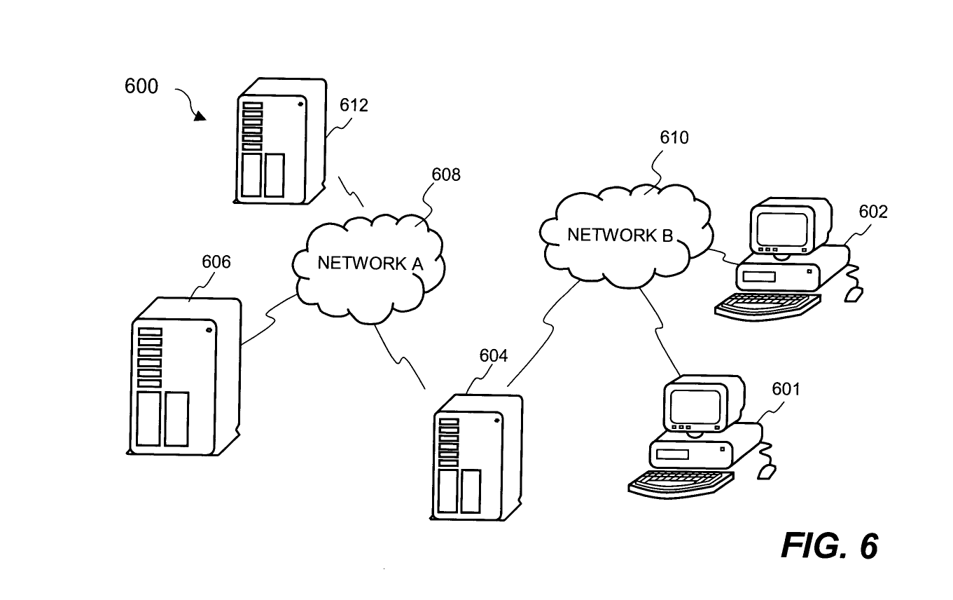

FIG. 6 shows a basic security system 600 in which the invention may be practiced in accordance with one embodiment thereof. The security system 600 may be employed in an enterprise or inter-enterprise environment. It includes a first server 606 (also referred to as a central server) providing centralized access management for the enterprise. The first server 606 can control restrictive access to files secured by the security system 600. To provide dependability, reliability and scalability of the system, one or more second servers 604 (also referred to as local servers, of which one is shown) may be employed to provide backup or distributed access management for users or client machines serviced locally. The server 604 is coupled to a network 608 and a network 610. For illustration purposes, there are two client machines 601 and 602 being serviced by the local server 604. Alternatively, one of the client machines 601 and 602 may be considered as a networked storage device.

Secured files may be stored in any one of the devices 601, 602, 604 and 606. When a user of the client machine 601 attempts to exchange a secured file with a remote destination 612 being used by an external user, the processes discussed above can be utilized to ensure that the requested secure file is delivered without compromising the security imposed on the secured file.

According to one embodiment, a created document is caused to go through an encryption process that is preferably transparent to a user. In other words, the created document is encrypted or decrypted under the authoring application so that the user is not aware of the process. One or more keys, such as a user key and a time-based access key, can be used to retrieve a file key to decrypt an encrypted document. Typically, the user key is associated with an access privilege for the user or a group of users, and the time-based access key is associated with a time restriction on the created document. For a given secured document, only a user with proper access privileges can access the secured document and then only after a time restriction, if present, is satisfied.

In one setting, a secured document may be uploaded via the network 610 from the client computer 601 to a computing or storage device 602 that may serve as a central repository. Although not necessary, the network 610 can provide a private link between the computer 601 and the computing or storage device 602. Such link may be provided by an internal network in an enterprise or a secured communication protocol (e.g., VPN and HTTPS) over a public network (e.g., the Internet). Alternatively, such link may simply be provided by a TCP/IP link. As such, secured documents on the computing or storage device 602 may be remotely accessed.

In another setting, the computer 601 and the computing or storage device 602 are inseparable, in which case the computing or storage device 602 may be a local store to retain secured documents or receive secured network resources (e.g., dynamic Web contents, results of a database query, or a live multimedia feed). Regardless of where the secured documents or secured resources are actually located, a user, with proper access privileges and satisfied time restrictions, can access the secured documents or resources from the client computer 601 or the computing or storage device 602 using an application (e.g., Microsoft Internet Explorer, Microsoft Word or Adobe Acrobat Reader).

Accordingly, respective local modules in local servers, in coordination with the central server, form a distributed mechanism to provide distributed access control enforcement. Such distributed access control enforcement ensures the dependability, reliability and scalability of centralized access control management undertaken by the central server for an entire enterprise or a business location.

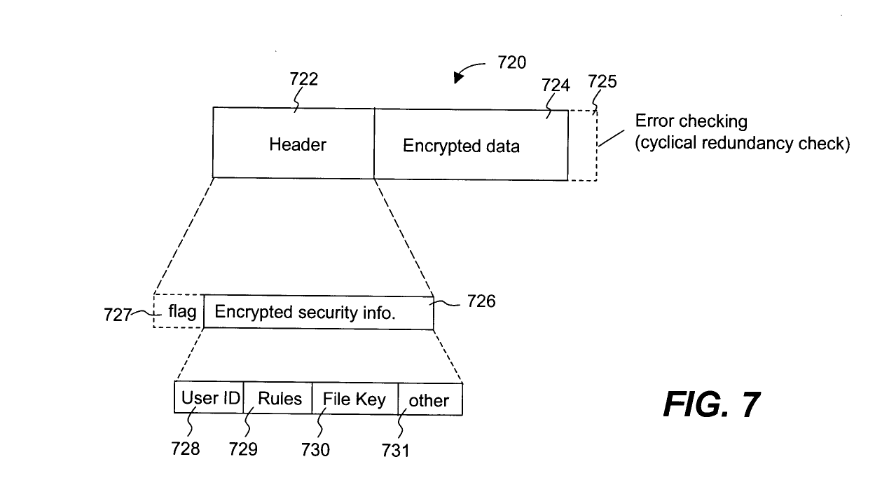

FIG. 7 shows an exemplary data structure 720 of a secured file that may be used in one embodiment of the invention. The data structure 720 includes two portions: a header (or header portion) 722 and encrypted data (or an encrypted data portion) 724. The header 722 can be generated in accordance with a security template associated with a data store and thus provides restrictive access to the data portion 724 which, for example, is an encrypted version of a plain file. Optionally, the data structure 720 may also include an error-checking portion 725 that stores one or more error-checking codes, for example, a separate error-checking code for each block of encrypted data 724. These error-checking codes may also be associated with a Cyclical Redundancy Check (CRC) for the header 722 and/or the encrypted data 724. The header 722 includes a flag bit or signature 727, and security information 726 that is in accordance with the security template for the data store. According to one embodiment, the security information 726 is encrypted and can be decrypted with a user key associated with an authenticated user (or requestor).

The security information 726 can vary depending upon implementation. However, as shown in FIG. 7, the security information 726 includes a user identifier (ID) 728, access policy (access rules) 729, keys (cryptographic keys) 730, and other information 731. Although multiple user identifiers may be used, a user identifier 728 is used to identify a user or a group that is permitted to access the secured file. The access rules 729 provide restrictive access to the encrypted data portion 724. The keys 730 are cipher keys (and/or pointers or indentifiers therefor) that, once obtained, can be used to decrypt the encrypted data portion 724 and thus, in general, are protected. In one implementation of the data structure 720, at least one of the keys 730 is encrypted in conjunction with the access rules 729. In another implementation of the data structure 720, at least one of the keys 730 is encrypted with a time-based access key and further protected by the access rules 729. The other information 731 is an additional space for other information to be stored within the security information 726. For example, the other information 731 may be used to include other information facilitating secure access to the secured file, such as version number or author identifier.

The invention is preferably implemented by software or a combination of hardware and software, but can also be implemented in hardware. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The various embodiments, implementations and features of the invention noted above can be combined in various ways or used separately. Those skilled in the art will understand from the description that the invention can be equally applied to or used in various other settings with respect to different combinations, embodiments, implementations or features as provided in the description herein.

The advantages of the invention are numerous. Different embodiments or implementations may yield one or more of the following advantages. One advantage of the invention is that electronic documents can be secured such that they can be unsecured only after some time in the future. Another advantage of the invention is that time-based access restrictions can be imposed on electronic documents in a cryptographically secure manner. Still another advantage of the invention is that the needed cryptographic keys to unsecure a secured electronic document are released by a server to a client only after a time restriction is satisfied.

The foregoing description of embodiments is illustrative of various aspects/embodiments of the present invention. Various modifications to the invention can be made to the preferred embodiments by those skilled in the art without departing from the true spirit and scope of the invention as defined by the appended claims. Accordingly, the scope of the present invention is defined by the appended claims rather than the foregoing description of embodiments.

1. A file security system for restricting access to electronic files, said file security system comprising:
a key store that stores a plurality of cryptographic key pairs, each of the cryptographic key pairs includes a public key and a private key, at least one of the cryptographic key pairs pertaining to a predetermined time; and
an access manager operatively connected to said key store, said access manager determines whether the private key of the at least one of the cryptographic key pairs pertaining to the predetermined time is permitted to be provided to a requestor based on a current time,
wherein the requester requires the private key of the at least one of the cryptographic key pairs pertaining to the predetermined time to access a secured electronic file, and wherein the secured electronic file was previously secured using the public key of the at least one of the cryptographic key pairs pertaining to the predetermined time.

2. A file security system as recited in claim 1, wherein said access manager only provides the private key of the at least one of the cryptographic key pairs pertaining to the predetermined time to the requester if the predetermined time is greater than or equal to the current time.

3. A file security system as recited in claim 1, wherein the requestor is a client module that operatively connects to said access manager over a network.

4. A file security system as recited in claim 1, wherein said document security system further comprises:
at least one client module, said client module assists a user in selecting the predetermined time, and said client module secures the electronic file using the public key of the at least one of the cryptographic key pairs pertaining to the predetermined time so as to provide a time-based access restriction to the electronic file.

5. A file security system as recited in claim 4, wherein said client module further assists in unsecuring the secured electronic file by acquiring the private key of the at least one of the cryptographic key pairs that pertaining to the predetermined time from said key store, and then unsecuring the secured electronic file using the private key of the at least one of the cryptographic key pairs that pertaining to the predetermined time.

6. A method for restricting access to an electronic document, said method comprising:
identifying an electronic document to be secured, the electronic document having at least a data portion that contains data;
obtaining a time-based access key;
securing the electronic document through use of the time-based access key to produce a secured electronic document; and
storing the secured electronic document.

7. A method as recited in claim 6, wherein the time-based access key has an access time associated therewith.

8. A method as recited in claim 7,
wherein said method further comprises:
storing the time-based access key at a remote key store, and
wherein the time-based access key is subsequently retrievable from the remote key store only if the current time equals or exceeds the access time associated with the time-based access key.

9. A method as recited in claim 8, wherein said method is performed on a client machine that operatively receives the time-based access key from the remote key store over a network.

10. A method for restricting access to an electronic document, said method comprising:
identifying an electronic document to be secured, the electronic document having at least a data portion that contains data;
obtaining a document key;
encrypting the data portion of the electronic document using the document key to produce an encrypted data portion;
obtaining a time-based access key;
encrypting the document key using the time-based access key to produce an encrypted document key;
forming a secured electronic document from at least the encrypted data portion and the encrypted document key; and
storing the secured electronic document.

11. A method as recited in claim 10, wherein the time-based access key is a public time-based access key.

12. A method as recited in claim 10, wherein the time-based access key has an access time associated therewith.

13. A method as recited in claim 12, wherein the time-based access key is available from a remote key store only if the current time equals or exceeds the access time associated with the time-based access key.

14. A method as recited in claim 13, wherein the access time is a day of a year, and the time-based access keys are unique for each day of the year.

15. A method as recited in claim 13, wherein said method is performed on a client machine that operatively receives the time-based access key from the remote key store over a network.

16. A method for accessing a secured electronic document by a requester, the secured electronic document having at least a header portion and a data portion, said method comprising:
obtaining a time-based access key;
obtaining an encrypted document key from the header portion of the secured electronic document;
decrypting the encrypted document key using the time-based access key to produce a document key;
decrypting an encrypted data portion of the secured electronic document using the document key to produce a data portion; and
supplying the data portion to the requestor.

17. A method as recited in claim 16, wherein the time-based access key is identified by an indicator within a header portion of the secured electronic document.

18. A method as recited in claim 16, wherein the time-based access key is a private time-based access key.

19. A method as recited in claim 18, wherein the time-based access key being obtained is acquired from a server.

20. A method as recited in claim 16, wherein said obtaining of the time-based access key is dependent on the current time.

21. A method as recited in claim 16, wherein the time-based access key is associated with an access time, and wherein said obtaining of the time-based access key is permitted only when the current time is greater than or equal to the access time.

22. A method as recited in claim 21, wherein, if permitted, said obtaining obtains the time-based access key being obtained from a server.

23. A method for distributing cryptographic keys used in a file security system, said method comprising:
receiving a request for a time-based key;
identifying an access time associated with the time-based key;
comparing the current time with the access time; and
refusing to distribute the time-based key in response to the request when said comparing indicates that the current time is prior to the access time.

24. A method as recited in claim 23, wherein the time-based key is a private time-based key.

25. A method as recited in claim 23, wherein said method is performed at a server, and wherein the request for the time-based key is from a client module that is connectable to the server via a network.

26. A computer readable medium including at least computer program code for restricting access to an electronic document, said computer readable medium comprising:
computer program code for identifying an electronic document to be secured, the electronic document having at least a data portion that contains data;
computer program code for obtaining a time-based access key;
computer program code for securing the electronic document through use of the time-based access key to produce a secured electronic document; and
computer program code for storing the secured electronic document.

27. A computer readable medium as recited in claim 26, wherein the time-based access key has an access time associated therewith.

28. A computer readable medium as recited in claim 27,
wherein said computer readable medium further comprises:
computer program code for storing the time-based access key at a remote key store, and
wherein the time-based access key is subsequently retrievable from the remote key store only if the current time equals or exceeds the access time associated with the time-based access key.
